(19) United States
(12) Patent Application Publication
(10) Pub. No.: US 2024/0417179 A1
(43) Pub. Date: Dec. 19, 2024

(54) MODULAR CONVEYOR BELT LINK

(71) Applicant: AMMERAAL BELTECH MODULAR A/S, Vejle (DK)

(72) Inventors: Kenneth Westergaard Andersen, Vejle (DK); Germ Buter, JR Alkmaar (NL)

(21) Appl. No.: 18/818,995

(22) Filed: Aug. 29, 2024

Related U.S. Application Data
(63) Continuation of application No. 17/607,963, filed on Nov. 1, 2021, now Pat. No. 12,134,522.

(30) Foreign Application Priority Data
May 3, 2019 (DK) PA 2019 70287

(51) Int. Cl. B65G 17/08; B65G 23/06

(52) U.S. Cl. CPC B65G 17/086; B65G 23/06; B65G 2207/24

(57) ABSTRACT

A conveyor belt link including central eye parts extending perpendicularly from said main body in forward and rearward directions, each said central eye part having said first thickness defining a belt thickness. The link includes an outermost end structure on a first end, said outermost end structure comprising: a first end eye part being of said first thickness, extending from said main body in a first direction along the conveying path, providing an engagement surface for engaging a driving rib of a drive element, and defining an outer side surface of the link, and a second end eye part extending from said main body in a second direction opposite the first direction and including a rib blocking structure having a second thickness that is less than said first thickness, said rib blocking structure being configured to prevent lateral engagement of the driving rib between the link and an adjacent link.

### CROSS-REFERENCE TO RELATED APPLICATIONS

This application is a continuation of co-pending application Ser. No. 17/607,963 filed in the U.S. on Nov. 1, 2021, which claims priority to PCT Application No. PCT/DK2020/050121, having a filing date of May 1, 2020, which is based on DK Application No. PA 2019 70287, having a filing date of May 3, 2019, the entire contents of each application mentioned above are hereby incorporated by reference.

### FIELD OF TECHNOLOGY

The following relates to a modular conveyor belt link, an endless conveyor assembled from a plurality of modular conveyor belt links as well as a spiral conveyor structure where the conveyor belt is made from a plurality of modular belt links.

### BACKGROUND

In the art, spiral conveyors are used to convey goods along a helically formed conveyor path. The conveyor belt will follow a conveying path around a drive tower. By this design of the conveyor, it is achieved that a relatively large conveyor belt area may be provided on a relatively small floor area. These types of conveyors are often used in combination with freezing installations or bakery installations such that the entire spiral conveyor is enclosed inside a housing where the desired process takes place.

### SUMMARY

In order to be able to transport a relatively high load it is necessary to obtain a firm connection between the drive means, typically in the shape of a drive tower arranged centrally inside the spiral conveyor and the conveyor belt, such that by rotating the drive tower the rotational forces will be transferred to the conveyor belt thereby moving the conveyor belt and thereby the objects through the spiral conveyor along the conveying path.

Embodiments of the present invention provide a novel solution to this engagement between the conveyor belt and the spiral conveyor drive tower by using the modular conveyor belt link of the type used in endless conveyor belts assembled from a plurality of such modular conveyor belt links, where the modular conveyor belt link has a main body extending in the modular belt link's width direction, and where a plurality of eye parts extend forwards and rearwards from the main body, the eye parts being spaced in the width direction of the modular belt link, where forward extending eye parts are offset relative to rearward extending eye parts, such that when two modular conveyor belt links are pushed together the eye parts on one link will inter-fit between eye parts on the other modular belt link, where the modular belt link laterally is limited by two sides, and that the outermost eye parts on either side are provided with a cutout, the cut-out spanning the entire thickness of the modular belt link from the load carrying surface to the underside, such that the width of the modular conveyor belt link is smaller in the cutout than outside the cutout.

The cutout in the sides of the modular conveyor belt link provides a well-defined engagement point where engagement members, for example provided on a spiral conveyor drive tower, may positively engage the modular conveyor belt link and transfer the propulsion forces from the drive tower to the modular conveyor belt link. The type of conveyor belts used in spiral conveyors are of the side flexing type, meaning that the conveyor belt will be able to flex to either side in a lateral plane. When the conveyor belt flexes to one side, the belt will collapse along the inner periphery, and be extended along the outer periphery.

Examples of such side-flexing conveyor belts are disclosed in U.S. Patent Application Publ. No. 2014/0231226, U.S. Patent Application Publ. No. 2008/0023304 and many others.

Usually, the inner side in the collapsed state will be substantially continuous in that adjacent outer eye parts along the periphery of adjacent rows of belt links, will be in contact. However, with embodiments of the present invention, where a cut-out is provided spanning through the entire thickness of the modular belt link, the cut-out provides an opening in which engagement means provided on the outside of the drive tower may engage, and thereby positively drive the conveyor belt along the helical path.

Also, for embodiments where the drive tower does not have positive drive means, the inner side surface of the modular belt links will be able to frictionally engage the periphery of the drive tower and thereby be propelled through the spiral conveyor.

In a further embodiment, the modular conveyor belt link has an upper carrying surface where the eye parts are provided with apertures parallel to the carrying surface, such that apertures in one eye part may be overlapped with apertures in eye parts from adjacent modular conveyor belt links, and a connection pin may be inserted through the overlapping apertures thereby creating a hinge-like connection between adjacent modular belt links.

The hinge-like connection provides the added advantage that it is possible to bend the conveyor belt out of a plane which is well-known in the art. Particularly for spiral conveyor belts these will alter orientation a number of times when going through the conveying path and as such this is an important aspect for this type of modular conveyor belt links.

In a still further embodiment, the apertures at least in eye parts on one side of the main body are oblong with the long axis of the aperture oriented in the intended transport direction for the endless conveyor belt into which the modular belt link is to be assembled. In this manner the modular conveyor belt link is suitable to be assembled in an endless conveyor belt where the oblong apertures allow the conveyor belt to side-flex and thereby firmly adapt to the conveying path, particularly in a spiral conveyor.

It is also foreseen that the eye parts, at least the outermost eye parts, have reduced material thickness orthogonally to the carrying surface such that the eye parts may slide over adjacent eye parts in modular belt links in front or to the rear. In this manner the side of the conveyor will not have gaps in which engagement members on the drive tower may be lodged, and furthermore the conveyor belt may not be diverted from the conveying belt guide path, due to a gap in the conveyor.

Embodiments of the invention are also directed to an endless conveyor belt assembled from a plurality of modular conveyor belt links as described above.

In embodiments, the modular conveyor belt link discussed above is particularly designed for use in a spiral conveyor structure where the spiral conveyor structure comprises a drive tower having a bottom and a top and engagement means extending between the bottom and top, where the drive tower rotates around a vertical axis. The engagement means extends a distance from the vertical rotation axis, where the distance varies at least for a part of the distance between the bottom and the top. The spiral conveyor structure further comprises a spiral pathway arranged outside the drive tower; and an endless modular conveyor belt assembled from a plurality of modular belt links arranged on the pathway, wherein an outer end of the engagement means engages the cutout provided in the innermost side of a modular belt link, such that as the drive tower rotates, the modular belt link and thereby the endless conveyor belt is pushed along the spiral pathway.

The engagement means provided substantially vertically on the drive tower are designed such that they will engage the cutout in the side-surfaces of the modular belt links and in this manner provide a positive engagement directly between the engagement means and the modular conveyor belt link. This feature provides a very well-defined engagement and also provides the possibility of transferring relatively large propulsion forces to the endless conveyor assembled from a plurality of modular conveyor belt links as described above.

### BRIEF DESCRIPTION

Some of the embodiments will be described in detail, with references to the following Figures, wherein like designations denote like members, wherein:

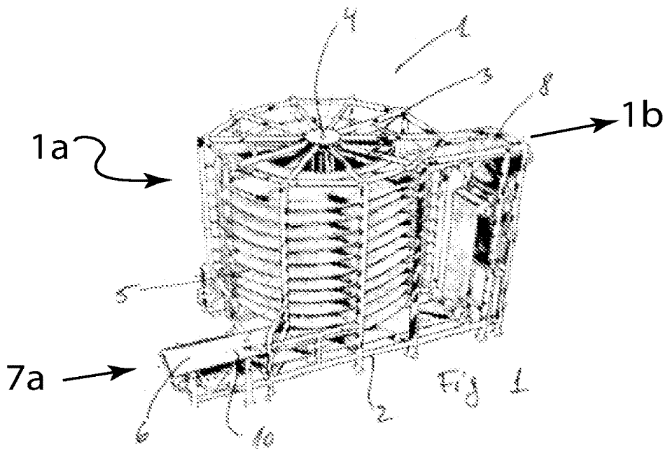

FIG. 1 shows a typical spiral conveyor construction;

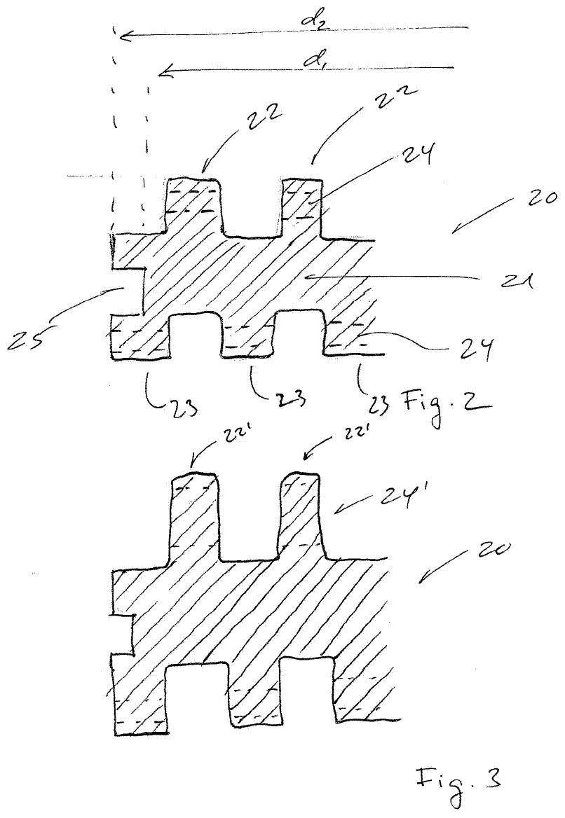

FIG. 2 shows schematic modular conveyor belt links according to an embodiment of the invention;

FIG. 3 shows schematic modular conveyor belt links according to a further embodiment of the invention;

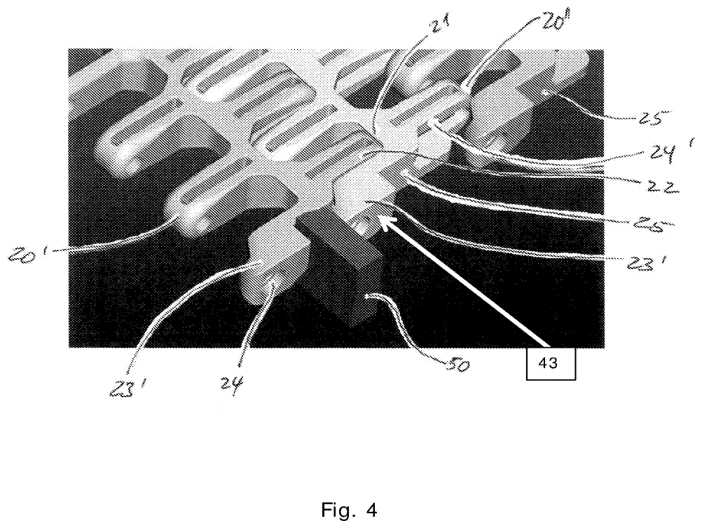

FIG. 4 shows a further embodiment of the invention where adjacent modular conveyor belt links are assembled to form a conveyor belt; and

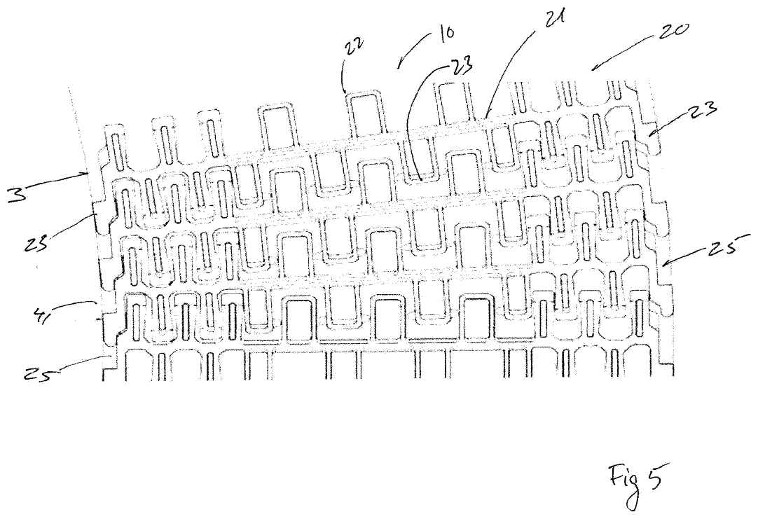

FIG. 5 shows a plane view of an endless conveyor belt assembled from a plurality of modular conveyor belt links.

### DETAILED DESCRIPTION

In FIG. 1 is illustrated a typical spiral conveyor construction comprising a frame structure 2 suitable to be placed on a floor of a manufacturing facility. Inside the frame structure 2 is provided a drive tower 3 which drive tower has a top and a bottom and where the drive tower 3 is arranged for rotation around a substantially vertical axis 4.

On the outside of the drive tower 3 is provided a conveying path 5. When an object is placed on the conveyor belt, at the entrance 6 to the spiral conveyor working in the direction as indicated by the arrow 7a, the object will be transported on a conveyor 10 through the spiral conveyor along the spiral/helical conveying path 5 and finally be arriving at the outlet 8 where the object transported by the spiral conveyor 1 will be ready for further processing by leaving the spiral conveyor 1 as indicated by the arrow 1b.

As may be seen by the illustration the conveyor belt 10 is relatively long in that the spirals of the spiral path circumvents the drive tower a number of times enlarging the effective conveying area compared to the area which the structure 1 takes up in a production facility. Furthermore, the drive tower 3 needs to engage the side of the conveyor belt 10 in order to propel the conveyor belt and the objects through the spiral part 1a of the conveying structure 1.

In FIGS. 2 and 3 are illustrated schematic embodiments of modular conveyor belt links according to embodiments of the invention.

In FIG. 2 the modular belt link 20 has a main body 21 which in this embodiment is illustrated as a solid slab. In other embodiments the main body may be perforated such that any water may drain from the surface or the main body may be very thin just being a beam going across the width of the modular conveyor belt link.

Eye parts 22 are extending rearwardly from the body 21 and similarly forward facing eye parts 23 are extending in a forward direction. The eye parts 22, 23 are offset such that eye parts facing rearward 22 may be interfitted between adjacent eye parts 23 facing forward. In this manner it is possible to create a large conveyor belt by inter-fitting substantially identical conveyor belt links in this manner.

The eye parts 22, 23 are also provided with a lateral aperture 24 (illustrated by dashed lines) such that by inserting the eye parts 22, 23 in the openings between the forward extending eye parts 23 it is possible to make the lateral apertures 24 overlap and insert a connection pin (not illustrated).

In this embodiment the outermost eye part 23 is provided with a cut-out 25 such that the width of the modular conveyor belt link DI is smaller in the cut-out than the entire width D2 of the belt link. As the modular conveyor belt link 20 is assembled into an endless conveyor belt as described above with reference to FIG. 2 engagement means on the drive tower will be able to engage the cut-out 25 on the modular conveyor belt links and in this manner positively engage and drive the endless conveyor belt along the drive tower.

In FIG. 3 is illustrated a further embodiment, however, in this embodiment the apertures 24′ (still illustrated by dashed lines) are oblong such that the longitudinal direction of the aperture is oriented in the intended travelling direction of the conveyor belt. It will therefore be possible when adjacent belt links are assembled as described above with reference to inserting a connecting pin through overlapping apertures for the connecting pin to move in the travelling direction inside the oblong aperture 24′ provided in the rearward-facing eye parts 22′. In this manner a sideflexing conveyor belt is constructed.

In FIG. 4 is illustrated a further embodiment of the invention where adjacent modular conveyor belt links 20′, 20″ are illustrated in an assembled manner. The modular belt links are identical and in this embodiment the outermost eye part 23′ is provided with a cut-out which allows the engagement member 50 on the drive tower (not illustrated) to engage the cut-out and positively drive the conveyor belt.

In this embodiment the cut-out is not a slit as it was in the embodiments illustrated above with reference to FIGS. 2 and 3, but is a cut-out where part of the material in the outermost eye part has been removed such that the outermost eye part 23′ of an adjacent outer eye part of a further modular belt link may overlap the first outer eye part 23′.

As may be further seen from FIG. 4 the belt links are dimensioned such that the rearward extending eye parts 22 engage the bottom/main body 21 of the adjacent modular belt link and in this manner ensures that the cut-out 23′ is free for the engagement member 50 to engage and drive the conveyor belt. In this embodiment the rearward-facing eye parts 22 are provided with oblong apertures 24′ whereas the forward facing eye parts 23′ are provided with circular apertures 24.

Furthermore, the outer side surface 43 (see also FIGS. 2 and 3) of the conveyor belt in the shape of outside side surfaces 43 of the modular belt links, may also be used to transfer propulsion force from a drive tower to the endless belt. In the art of spiral conveyors there are generally two concepts of transferring power from the drive tower to an endless belt: positive drive and friction drive. In FIG. 4 for example is illustrated positive drive. By this concept shall be understood that the endless conveyor is provided with means, typically notches, ribs or the like which are provided and suitable to engage means on the drive tower, such that there are determined engagement positions between the endless conveyor belt and the drive tower. In the other type—friction—an outer surface on the drive tower will frictionally engage a side face of the conveyor belt. Due to the tension in the belt surrounding (causing a slight squeezing) the drive tower and the friction against the drive tower, the frictional engagement will transfer propulsion force to the endless conveyor belt.

In FIG. 5 is illustrated a plane view of an endless conveyor belt 10 assembled from a plurality of modular conveyor belt links 20 according to embodiments of the invention. Each modular conveyor belt link 20 has a main body 21 from which eye parts 22, 23 extend in rearward and forward directions, respectively.

The outermost eye parts 23 in both sides of the conveyor belt are provided with cut-outs 25 such that engagement means (not illustrated) on the drive tower 3 may engage and propel the conveyor belt 10 along the conveying path 5 (see FIG. 1). The depth 41 of the cut-out illustrated by the arrow is sufficient for the engagement member 50, see FIG. 4, to be inserted in the cut-out 25 sufficiently to attain a firm contact with the conveyor belt and as such be able to drive the conveyor belt in the desired direction.

As is evident from FIG. 5 the side of the conveyor belt closer to the drive tower 3 is collapsed such that the distance between adjacent eye parts along the inner side is substantially smaller than the same distance along the outer side of the conveyor belt. This is due to the provision of the elongated apertures 24′ as explained with reference to FIGS. 3 and 4.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. A modular conveyor belt link configured to be assembled in interfitting relationship with a plurality of like modular conveyor belt links, which may be connected together with connection pins to form an endless conveyor belt with a load carrying surface and an underside opposite the load carrying surface, the endless conveyor belt defining a forward direction and a rearward direction extending in opposing directions along a conveying path, and a belt thickness between the load carrying surface and the underside of the belt, the modular conveyor belt link comprising:
a main body having a first thickness configured to define the belt thickness when the link is assembled with other links;
a plurality of central eye parts extending perpendicularly from said main body in forward and rearward directions, each said central eye part also being of said first thickness;
an outermost end structure on a first end of said modular conveyor belt link, said outermost end structure comprising:
a first end eye part being of said first thickness, extending from said main body in a first direction along the conveying path, providing an engagement surface for engaging a driving rib of a drive element, and defining an outer side surface of the link, and
a second end eye part extending from said main body in a second direction opposite the first direction along the conveying path and including a rib blocking structure having a second thickness that is less than said first thickness, said rib blocking structure being configured to prevent lateral engagement of the driving rib inward between the link and an adjacent link beyond said rib blocking structure.

2. The modular conveyor belt link of claim 1, wherein, when the link is assembled with other links to form a conveyor belt, a first surface of said rib blocking structure is flush with the underside or load carrying surface of the conveyor belt.

3. The modular conveyor belt link of claim 2, wherein, when the link is assembled with other links to form a conveyor belt, a second surface of the rib blocking structure is disposed part way between the load carrying surface of the belt and the underside of the belt, such that the second surface of the rib blocking structure is recessed from the underside or the load carrying surface of the belt.

4. The modular conveyor belt link of claim 1, wherein the rib blocking structure includes a horizontally oriented flange.

5. The modular conveyor belt link of claim 4, wherein the first end eye part includes a recess configured to receive a horizontally oriented flange of a rib blocking structure of an adjacent link when the link and the adjacent link are arranged in a collapsed belt condition.

6. The modular conveyor belt link of claim 5, wherein the recess is located in a bottom portion or a top portion of the first eye part.

7. A modular conveyor belt link configured to be assembled in interfitting relationship with a plurality of like modular conveyor belt links to form a modular conveyor belt defining a load carrying surface and an underside opposite the load carrying surface, the modular conveyor belt link comprising:
a main body configured to extend laterally across a conveyor belt when assembled with other links;
an outermost end structure on a lateral end of the modular conveyor belt link, said outermost end structure comprising:
a first end portion having said first thickness, extending from said main body in a first direction along a conveying path of the belt, and providing an engagement surface for engaging a driving rib of a drive element; and
a second end portion extending from the main body in a second direction opposite the first direction along the conveying path of the belt and including a rib blocking structure having a second thickness that is less than said first thickness, the rib blocking structure being configured to prevent lateral engagement of the driving rib inward between the link and an adjacent link beyond the rib blocking structure when the link is assembled with other links.

8. The modular conveyor belt link of claim 7, wherein, when the link is assembled with other links to form a conveyor belt, a first surface of said rib blocking structure is flush with the underside or load carrying surface of the conveyor belt.

9. The modular conveyor belt link of claim 8, wherein, when the link is assembled with other links to form a conveyor belt, a second surface of the rib blocking structure is disposed part way between a load carrying surface of the belt and an underside of the belt, such that the second surface of the rib blocking structure is recessed from the load carrying surface or the underside of the belt.

10. The modular conveyor belt link of claim 7, wherein the rib blocking structure includes a horizontally oriented flange.

11. The modular conveyor belt link of claim 10, wherein the first end portion of the link includes a recess configured to receive a horizontally oriented flange of a rib blocking structure of an adjacent link when the link and the adjacent link are arranged in a collapsed belt condition.

12. The modular conveyor belt link of claim 11, wherein the recess is located in a bottom portion or a top portion of the first end portion.

13. A modular conveyor belt, comprising;
a first link comprising:
a first main body extending laterally across a width of the conveyor belt; and
a first end portion having a first thickness, extending in a first direction from said first main body along a conveying path of the conveyor belt, and providing an engagement surface for engaging a driving rib of a drive element; and
a second link configured to be assembled in interfitting relationship with the first link, the second link comprising:
a second main body extending laterally across the width of the conveyor belt; and
a second end portion extending in a second direction from the main body along the conveying path opposite the first direction, the second end portion including a rib blocking structure having a reduced material thickness as compared to the first end portion;
wherein, when the first link and the second link are assembled together and the conveyor belt is in an expanded condition, the rib blocking structure extends between the first link and the second link to prevent a driving rib of a drive element from getting lodged between the first link and the second link.

14. The modular conveyor belt of claim 13, wherein the rib blocking structure includes a horizontally oriented flange.

15. The modular conveyor belt of claim 14, wherein the first end portion of the first link includes a recess configured to receive the horizontally oriented flange of the rib blocking structure when the conveyor belt is in a collapsed condition.

16. The modular conveyor belt of claim 14, wherein a first surface of the horizontally oriented flange of the rib blocking structure is flush with an underside or a load carrying surface of the conveyor belt.

17. The modular conveyor belt of claim 16, wherein a second surface of the horizontally oriented flange of the rib blocking structure is disposed part way between the load carrying surface of the belt and the underside of the belt, such that the second surface of the rib blocking structure is recessed from the underside or the load carrying surface of the belt.

18. The modular conveyor belt of claim 13, wherein the first end portion and the second end portion include apertures that extend parallel to a load carrying surface of the belt.

19. The modular conveyor belt of claim 18, wherein, when the first link and the second link are disposed in interfitting arrangement, the apertures overlap with one another; and
wherein the belt further includes a connection pin inserted through the overlapping apertures.

20. The modular conveyor belt of claim 19, wherein the apertures are oblong with a long axis of each aperture oriented along the path of travel of the belt; and
wherein the oblong configuration of the apertures enables expansion and collapse of the belt along the conveying path.
